(19) United States
(12) Patent Application Publication
(10) Pub. No.: US 2024/0049014 A1
(43) Pub. Date: Feb. 8, 2024

(54) METHOD FOR CONDUCTING VEHICLE-TO-X COMMUNICATION AND VEHICLE-TO-X COMMUNICATION MODULE

(71) Applicant: Continental Automotive Technologies GmbH, Hannover (DE)

(72) Inventors: Marc Menzel, Weimar (Lahn) (DE); Ingolf Koch, Oberursel (Taunus) (DE); Holger Föhre, Giessen-Lützellinden (DE); Christof Rinn, Biebertal (DE); Markus Weckesser, Wetzlar (DE)

(73) Assignee: Continental Automotive Technologies GmbH, Hannover (DE)

(21) Appl. No.: 18/230,476

(22) Filed: Aug. 4, 2023

(30) Foreign Application Priority Data
Aug. 4, 2022 (DE) 10 2022 208 146.3

(51) Int. Cl. H04W 24/08; H04L 1/20

(52) U.S. Cl. CPC H04W 24/08; H04L 1/203

(57) ABSTRACT

A vehicle-to-X communication module may execute a method for conducting vehicle-to-X communication comprising at least the step of determining a reception quality for vehicle-to-X messages. Different embodiments may be used for this purpose.

### BRIEF DESCRIPTION OF THE DRAWINGS

Features and advantages may be gathered from the exemplary embodiment described below with reference to the appended drawing, in which:

FIG. 1 illustrates an exemplary arrangement comprising two vehicles and one infrastructure unit.

### DETAILED DESCRIPTION

The disclosure relates to a method for conducting vehicle-to-X communication and an associated vehicle-to-X communication module.

Vehicle-to-X communication is currently in a phase of standardization and development. Vehicle-to-X communication may provide information in a vehicle, which may originate from other vehicles or from infrastructure facilities, and which may lead to a significant increase in traffic safety and better traffic management. A vehicle may use it to receive information about the surrounding traffic flow, hazardous situations and the condition of traffic areas, which may significantly exceed what a vehicle may detect with its own environmental sensors.

It is an object of the disclosure to provide a method for conducting vehicle-to-X communication, which is designed in an alternative or better manner than known embodiments. A further object of the disclosure is to provide an associated vehicle-to-X communication module.

The disclosure further relates to a method for conducting vehicle-to-X communication, wherein the method comprises at least determining a reception quality for vehicle-to-X messages.

In addition to the information contained in the respective vehicle-to-X messages, which relates, for example, to other road users or infrastructure facilities, the reception quality of the received vehicle-to-X messages may also be provided as information in the vehicle. This may be used to assess how reliable the vehicle-to-X messages and the information they contain are. This allows considerably better control of downstream processing steps or processing units, as these may incorporate the reliability of the information obtained into further calculations. For example, it is possible to determine whether or not the vehicle-to-X messages were received and the information contained therein may be used for a certain degree of autonomous control of a vehicle. For example, the reception quality may be specified as a numeric value within a specified range.

Conducting vehicle-to-X communication includes sending and/or receiving vehicle-to-X messages. Vehicle-to-X messages sent may contain information that was generated on the vehicle or received from other vehicles or infrastructure facilities and is merely forwarded. Vehicle-to-X messages received may include information about other vehicles, about the general traffic conditions, hazardous situations or the condition of traffic areas. The reception quality may refer to vehicle-to-X messages received.

The method preferably additionally comprises determining a reliability based on reception quality.

The reliability may then be available as additional information in the vehicle and may be used by downstream units such as an autonomous vehicle control system or an assistance system. For example, the reliability may be determined by specifying the degree to which autonomous driving is possible based on the vehicle-to-X messages. For example, it may be specified as a numeric value within a given range.

According to one embodiment, pilot tones and messages are received, wherein the reception quality is determined at least on the basis of a ratio between a number of received pilot tones and a number of received messages. Pilot tones may be transmitted or received items of information, which may have significantly fewer symbols than messages and which indicate that a vehicle-to-X message will follow. This allows a vehicle-to-X communication module to be available to receive an expected vehicle-to-X message. The relationship between pilot tones and received messages may be used to determine the reception quality. The higher the ratio of received messages to pilot tones, the higher the reception quality may be determined.

Pilot tones may have six to ten symbols, or eight symbols. This corresponds to typical numbers of pilot tone symbols. Messages may have five times as many symbols as pilot tones or more. This allows information to be transmitted in messages, whereas pilot tones may only announce one message at a time. For example, messages may have at least 80 symbols or may have at least 100 symbols.

In some examples, only fully received messages are taken into account in determining the reception quality. A pilot tone is typically followed by an announced message, which may either be received completely or incompletely. An incompletely received message may be one that is affected by reception problems and therefore may not be completely decoded. By taking into account only fully received messages when determining the reception quality, the reception quality may be advantageously estimated when determining a ratio of received messages to pilot tones on which it is based.

According to one embodiment, a packet error rate is determined, wherein the reception quality is determined at least on the basis of the packet error rate. The packet error rate may be calculated as the ratio of a number of received packets in which a checksum does not correspond to the payload, to a number of received packets in which a checksum corresponds to the payload. If a checksum corresponds to the payload, this may mean that the checksum is calculated correctly from the payload based on a specified rule. This indicates that the message was correctly transmitted and received. In contrast, if the checksum does not correspond to the payload, this may indicate that the message was not received correctly. This indicates poor reception quality.

According to one embodiment, a signal-to-noise ratio is determined, wherein the reception quality is determined at least on the basis of the signal-to-noise ratio. The signal-to-noise ratio may be calculated as the ratio of a signal strength immediately after a pilot tone within a message to a signal strength of a noise level outside of messages and pilot tones. A signal-to-noise ratio determined in this way results in a direct indication of the reception quality. The higher the signal-to-noise ratio, the better the reception quality typically is.

According to one embodiment the reception quality is determined at least on the basis of quality data received from a central server. Such a central server may provide quality data for different areas which are determined centrally, for example based on topographic maps or based on feedback from vehicles. The quality data may be map-based. For example, a vehicle may communicate its current position to the central server and receive quality data from the central server in return, which is determined based on the position and stored data. The central server may communicate with vehicles, for example, via vehicle-to-X communication or via a mobile radio network.

According to one embodiment the reception quality is determined at least on the basis of quality data received from one or more other vehicles. This means that other vehicles may also contribute to determining the reception quality, or in other words, vehicles may assist each other in determining the reception quality.

According to one embodiment the reception quality is determined at least on the basis of a vehicle's on-board map. As a result, information on reception quality and/or information on factors influencing the reception quality may also be stored in the vehicle—in a similar way to the central server. This information may be based, for example, on previously determined reception qualities and/or on generally provided data.

The vehicle's on-board map may contain topographic data, data on objects that obstruct radio propagation, and/or data regarding the reflection of radio waves at objects. Based on this type of data, a reception quality may be advantageously determined. Alternatively or in addition, data may also be included which directly indicates the reception quality. For example, the data may be specific to a defined area.

It should be understood that the above-mentioned embodiments for determining reception quality may also be combined with each other and among themselves. Arbitrary groups of the described embodiments may thus be formed which are present in a specific implementation, in order to determine a reception quality by means of one or more described procedures.

The disclosure further relates to a vehicle-to-X communication module, which is configured to carry out a method as described herein. The disclosure furthermore relates to a non-volatile, computer-readable storage medium on which program code is stored, during the execution of which a processor executes a method as described here. In respect of the method described herein, reference may in each case be made here to all of the embodiments and variants described herein.

Vehicle-to-X communication may, for example, utilize standards, such as, for example, IEEE 802.11(p), IEEE 1609, SAE 2735, SAE 2945, and ETSI ITS-G5. In addition, new standards are currently being introduced at 3GPP for C-V2X and/or LTE-V2X or 5G-V2X. However, the described solution is not limited to the communication technologies mentioned. For example, IEC 61508 or ISO 26262 discuss concerns over functional safety.

Vehicle-to-X communication systems are currently defined as ASIL QM, and the current standards do not envisage use in functions that are defined as critical by ISO 26262 (ASIL>QM). It is particularly critical that there is currently no way to ensure the availability of vehicle-to-X communication signals at the receiver or even to diagnose impaired reception.

Therefore, methods are described in this document that allow the availability of vehicle-to-X communication signals to be diagnosed, either directly or via redundant information, so that a higher-level system may decide whether the information will need to be substituted, for example by environmental sensors, or whether the entire system has to switch to an emergency mode, for example because response times may not be maintained without the vehicle-to-X communication signals.

In principle, the following text distinguishes between the diagnosis of arbitrary vehicle-to-X communication signals and specific roadside unit signals.

Firstly, on the diagnosis of arbitrary signals:

The V2X radio chipset detects potential V2X signals from so-called pilot tones, but their detection is typically not passed on to the subsequent processing steps, but only a completely decoded packet. If, in addition to forwarding the decoded packets, the number of detected pilot tones in the last 10 to 100 ms (adjustable time window, depending on the Failure Tolerance Time (FTT)) is also reported to the higher processing layers, these may indicate a probability of whether V2X signals have been lost or not. In addition to the time window, a threshold for the signal strength of the detected signal tones may be introduced in order to report only those pilot tones that potentially originate from adjacent stations. Pilot tone detection is less sensitive than full packet decoding because they are significantly shorter and use more robust modeling, resulting in lower bit and packet error rates.

A significant difference between the number of decoded messages and detected pilot tones indicates a noisy transmission channel, particularly at high signal strengths, and thus the availability of the received vehicle-to-X signals is also highly likely to be impaired.

In addition or alternatively, the observation of packet error rates (PER) and/or the signal-to-noise ratio (SNR) may also provide indications of the quality of the reception conditions. Packet error rates may be calculated for each V2X station, which may be identified in the V2X messages via its temporary station ID, and the packet counters that are also included, as is already the case in the American DCC procedure, for example. Ideally, the DCC calculation of the PER may be reused. The SNR is generated as a measured value in the V2X radio chipset.

The PER and SNR are of particular interest in use cases such as platooning, where vehicles travel close together over a longer period of time and are dependent on almost all V2X messages arriving at the other vehicles in the platoon. As soon as the PER increases or the SNR decreases, the distance between the vehicles may be increased in order to increase the FTT and thus be more robust against the loss of multiple V2X packages.

There are additional methods for diagnosing the availability of V2X signals originating from Road Side Units (RSU). For example, a digital map (e.g. eHorizon (eH)) that meets the functional safety requirement to locate RSU positions and calculate the probability of receiving V2X signals may be used. To enable this, the map typically contains information that describes the permeability of a geographic structure. Ideally, the reflectivity is also mapped to calculate the propagation of signals due to reflections. Instead of the statistical map, or to supplement or correct it, RSU positions may be collected by a V2X-equipped vehicle and forwarded to the eH server. For example, information would include the location from the V2X messages, the signal strength, and the SNR. From this information, the eH server may then generate the necessary map information, preferably by combining the data from multiple vehicles. Of course, this may also be carried out locally in the vehicle, in which case the vehicles would ideally send their respective measured values to each other, so that each one may generate a map of the reception conditions around an RSU.

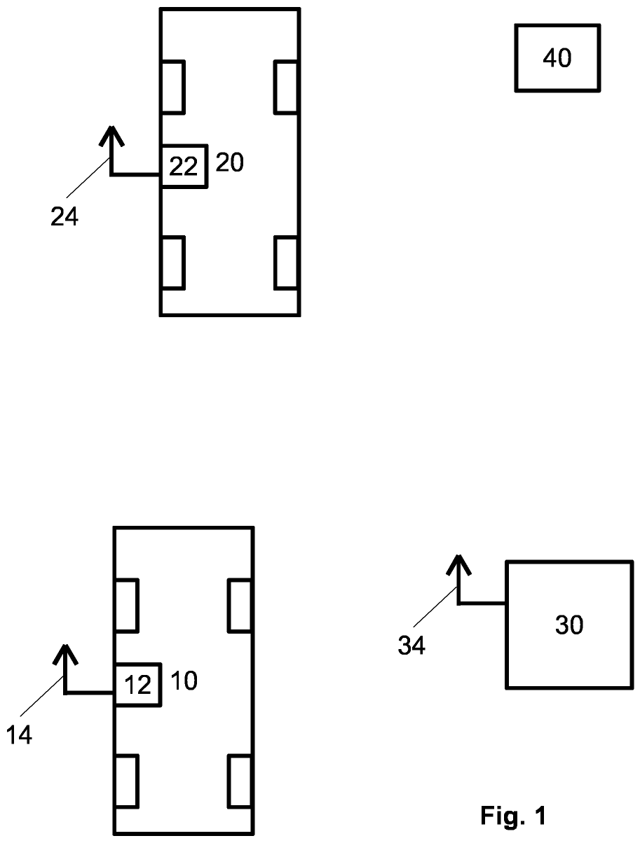

FIG. 1 shows an arrangement of a first vehicle 10, a second vehicle 20, an infrastructure unit 30 and a central server 40. The first vehicle 10 comprises a first vehicle-to-X communication module 12 with a first antenna 14 connected to it. The second vehicle 20 has a second vehicle-to-X communication module 22 with a second antenna 24 connected to it. The infrastructure unit 30 is arranged on the roadside and has a third antenna 34.

An embodiment shown allows the first vehicle 10, the second vehicle 20 and the infrastructure unit 30 to communicate with each other by means of vehicle-to-X communication. To do this, vehicle-to-X messages are exchanged. However, in the embodiment described herein a vehicle 10, 20 that receives vehicle-to-X messages may not only evaluate the information contained in the decoded messages, but also generates a measure of the reception quality. For this purpose, the procedure described above is used to calculate a ratio of received pilot tones to decoded messages and to determine the reception quality on this basis. In addition, a signal-to-noise ratio of received messages is calculated. The higher the ratio of decoded messages to pilot tones and the higher the signal-to-noise ratio, the higher the reception quality is determined for one of the vehicles 10, 20.

In addition, the vehicles 10, 20 receive messages from the central server 40 via a mobile communications infrastructure that is not shown, which provide information on reception quality. This may include, for example, information on propagation conditions or high buildings. This information also enters into the calculation of the reception quality.

Based on the reception quality determined in each case, a reliability is determined, which indicates to subsequent units in the respective vehicles 10, 20 how reliable the information received via the vehicle-to-X communication is. Accordingly, it may be decided, for example, whether this information may be used for functionalities such as autonomous vehicle control or platooning. The usability of vehicle-to-X messages is significantly improved without sacrificing safety.

The mentioned steps of the method according to the disclosure may be executed in the order indicated. However, they may also be executed in a different order, insofar as is technically appropriate. In one of its embodiments, for example with a specific combination of steps, the method according to the disclosure may be executed in such a way that no further steps are executed. However, in principle, further steps may also be executed, including steps that have not been mentioned.

In general, it should be pointed out that vehicle-to-X communication may be understood to mean a direct communication between vehicles and/or between vehicles and infrastructure devices. By way of example, it may thus be vehicle-to-vehicle communication or vehicle-to-infrastructure communication. Where this application refers to a communication between vehicles, said communication may fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication may be effected using the IEEE 802.11p or IEEE 1609.4 standard. Other examples of communication technologies include LTE-V2X, 5G-V2X, C-V2X, WLAN, WiMax, UWB or Bluetooth. A vehicle-to-X communication may also be referred to as C2X communication. The subareas may be referred to as C2C (car-to-car) or C2I (car-to-infrastructure). However, the disclosure explicitly does not exclude vehicle-to-X communication with switching via a mobile radio network, for example.

Clause 1. A method for conducting vehicle-to-X communication, wherein the method comprises at least determining a reception quality for vehicle-to-X messages.

Clause 2. The method of clause 1, which further comprises determining a reliability based on reception quality.

Clause 3. The method of any of the preceding clauses, wherein pilot tones and messages are received, and wherein the reception quality is determined at least based on a ratio between a number of received pilot tones and a number of received messages.

Clause 4. The method of clause 3, wherein pilot tones have 6 to 10 symbols, or 8 symbols; and/or wherein messages have at least five times as many symbols as pilot tones; and/or wherein messages have at least 80 symbols or have at least 100 symbols.

Clause 5. The method of clause 3 or 4, wherein only fully received messages are taken into account in determining the reception quality.

Clause 6. The method of any of the preceding clauses, wherein a packet error rate is determined, and wherein the reception quality is determined at least based on the packet error rate.

Clause 7. The method of clause 6, wherein the packet error rate is calculated as the ratio of a number of received packets in which a checksum does not correspond to the payload, to a number of received packets in which a checksum corresponds to the payload.

Clause 8. The method as of any of the preceding clauses, wherein a signal-to-noise ratio is determined, and wherein the reception quality is determined at least based on the signal-to-noise ratio.

Clause 9. The method of clause 8, wherein the signal-to-noise ratio is calculated as the ratio of a signal strength immediately after a pilot tone within a message to a signal strength of a noise outside of messages and pilot tones.

Clause 10. The method of any of the preceding clauses, wherein the reception quality is determined at least on the basis of quality data received from a central server.

Clause 11. The method of clause 10, wherein the quality data is map-based.

Clause 12. The method of any of the preceding clauses, wherein the reception quality is determined at least on the basis of quality data received from a plurality of other vehicles.

Clause 13. The method any of the preceding clauses, wherein the reception quality is determined at least based on an on-board map.

Clause 14. The method of clause 13, wherein the on-board map contains topographic data, data on objects that obstruct radio propagation, and/or data regarding the reflection of radio waves at objects.

Clause 15. A vehicle-to-X communication module which is configured to execute a method of any of the preceding clauses.

Features may be described in combination in the disclosure, including the claims and drawings, for example in order to facilitate understanding, even though these may also be used separately from one another. A person skilled in the art will recognize that such features, independently of one another, may also be combined with other features or combinations of features.

Although the disclosure, including the claims and drawings, may characterize preferred combinations of the respective features it does not exclude other combinations of features.

1. A method for conducting vehicle-to-X communication, the method comprising:
determining a reception quality for vehicle-to-X messages.

2. The method as claimed in claim 1, further comprising:
determining reliability based on reception quality.

3. The method as claimed in claim 1,
wherein pilot tones and messages are received, and
wherein the reception quality is determined based at least in part on a ratio between number of received pilot tones and number of received messages.

4. The method as claimed in claim 3, wherein at least one of:
pilot tones have 6 to 10 symbols,
messages have at least five times as many symbols as pilot tones, and messages have at least 80 symbols.

5. The method as claimed in claim 3,
wherein only fully received messages are taken into account in determining the reception quality.

6. The method as claimed in claim 1,
wherein a packet error rate is determined, and
wherein the reception quality is determined at least based on the packet error rate.

7. The method as claimed in claim 6,
wherein the packet error rate is calculated as a ratio of a number of received packets in which a checksum does not correspond to a payload, to a number of received packets in which a checksum corresponds to the payload.

8. The method as claimed in claim 1,
wherein a signal-to-noise ratio is determined, and
wherein the reception quality is determined at least based on the signal-to-noise ratio.

9. The method as claimed in claim 8,
wherein the signal-to-noise ratio is calculated as a ratio of signal strength immediately after a pilot tone within a message to signal strength of noise outside of messages and pilot tones.

10. The method as claimed in claim 1,
wherein the reception quality is determined at least in part based on quality data received from a central server.

11. The method as claimed in claim 10,
wherein the quality data is map-based.

12. The method as claimed in claim 1,
wherein the reception quality is determined based at least in part on quality data received from a plurality of other vehicles.

13. The method as claimed in claim 1,
wherein the reception quality is determined at least based on an on-board map.

14. The method as claimed in claim 13,
wherein the on-board map contains topographic data, data on objects that obstruct radio propagation, and/or data regarding reflection of radio waves at objects.

15. A vehicle-to-X communication module configured to execute the method as claimed in claim 1.

16. The module as claimed in claim 15, wherein the method further comprises determining reliability based on reception quality.

17. The module as claimed in claim 15,
wherein a packet error rate is determined, and
wherein the reception quality is determined at least based on the packet error rate.

18. The module as claimed in claim 15,
wherein pilot tones and messages are received, and
wherein the reception quality is determined based at least in part on a ratio between number of received pilot tones and number of received messages.

19. The module as claimed in claim 18, wherein at least one of:
pilot tones have 6 to 10 symbols,
messages have at least five times as many symbols as pilot tones, and messages have at least 80 symbols.

20. The module as claimed in claim 18,
wherein only fully received messages are taken into account in determining the reception quality.
